(19) United States
(12) Patent Application Publication
(10) Pub. No.: US 2025/0024330 A1
(43) Pub. Date: Jan. 16, 2025

(54) INFORMATION FEEDBACK METHOD AND APPARATUS, AND DEVICE

(71) Applicant: VIVO MOBILE COMMUNICATION CO., LTD., Guangdong (CN)

(72) Inventor: Tong ZHOU, Guangdong (CN)

(73) Assignee: VIVO MOBILE COMMUNICATION CO., LTD., Guangdong (CN)

(21) Appl. No.: 18/901,869

(22) Filed: Sep. 30, 2024

Related U.S. Application Data
(63) Continuation of application No. PCT/CN2023/085491, filed on Mar. 31, 2023.

(30) Foreign Application Priority Data
Apr. 2, 2022 (CN) 202210350469.2

(51) Int. Cl. H04W 28/18

(52) U.S. Cl. CPC H04W 28/18

(57) ABSTRACT

This application discloses an information feedback method and apparatus, and a device. The information feedback method in embodiments of this application includes: receiving, by a first device, requirement information sent by a second device, where the requirement information is used to indicate a requirement corresponding to an artificial intelligence AI service; and sending, by the first device, feedback information of the requirement information to the second device, where the feedback information is used to indicate whether to agree with a requirement corresponding to the requirement information.

### CROSS-REFERENCE TO RELATED APPLICATIONS

This application is a Bypass continuation application of PCT International Application No. PCT/CN2023/085491 filed on Mar. 31, 2023, which claims priority to Chinese Patent Application No. 202210350469.2, filed in China on Apr. 2, 2022, which is incorporated herein by reference in its entirety.

### TECHNICAL FIELD

This application pertains to the field of communication technologies, and specifically relates to an information feedback method and apparatus, and a device.

### BACKGROUND OF THE INVENTION

Wireless mobile communication combined with artificial intelligence (AI) can better improve communication quality, for example, AI-based channel quality compression, AI-based beam management, and AI-based positioning. Taking beam management as an example, in millimeter-wave wireless communication, a plurality of analog beams are configured for a communication transceiver end (for example, a base station and a terminal). For a same terminal, channel quality measured at different transmit and receive analog beams changes. How to quickly and accurately select a transmit and receive beam group with the highest channel quality from all possible transmit and receive analog beam combinations is a key to affecting transmission quality. After an AI neural network model is introduced, the terminal may effectively predict transmit and receive analog beams with the highest channel quality based on the AI neural network model, and report the transmit and receive analog beams to a network side, so that better transmission quality can be obtained.

A first device (for example, a terminal or a base station) receives an AI service requirement sent by a second device (for example, a core network element), and implements the AI service requirement, so that the second device can implement the split AI service requirement through the first device, so as to implement a complex AI service. However, the first device may affect normal operating of the device when implementing the AI service requirement, causing the first device not to work normally.

### SUMMARY OF THE INVENTION

Embodiments of this application provide an information feedback method and apparatus, and a device.

According to a first aspect, an information feedback method is provided, including:
receiving, by a first device, requirement information sent by a second device, where the requirement information is used to indicate a requirement corresponding to an artificial intelligence AI service; and
sending, by the first device, feedback information of the requirement information to the second device, where the feedback information is used to indicate whether to agree with a requirement corresponding to the requirement information.

According to a second aspect, an information feedback method is provided, including:
sending, by a second device, requirement information to a first device, where the requirement information is used to indicate a requirement corresponding to an artificial intelligence AI service; and
receiving, by the second device, feedback information of the requirement information and sent by the first device, where the feedback information is used to indicate whether to agree with a requirement corresponding to the requirement information.

According to a third aspect, an information feedback apparatus is provided. A first device includes the information feedback apparatus, and the apparatus includes:
a receiving module, configured to receive requirement information sent by a second device, where the requirement information is used to indicate a requirement corresponding to an artificial intelligence AI service; and
a sending module, configured to send feedback information of the requirement information to the second device, where the feedback information is used to indicate whether to agree with a requirement corresponding to the requirement information.

According to a fourth aspect, an information feedback apparatus is provided. A second device includes the information feedback apparatus, and the apparatus includes:
a sending module, configured to send requirement information to a first device, where the requirement information is used to indicate a requirement corresponding to an artificial intelligence AI service; and
a receiving module, configured to receive feedback information of the requirement information and sent by the first device, where the feedback information is used to indicate whether to agree with a requirement corresponding to the requirement information.

According to a fifth aspect, a first device is provided. The first device includes a processor and a memory, the memory stores a program or an instruction that can be run on the processor, and the program or the instruction is executed by the processor to implement the steps of the method according to the first aspect.

According to a sixth aspect, a first device is provided, including a processor and a communication interface. The communication interface is configured to receive requirement information sent by a second device, where the requirement information is used to indicate a requirement corresponding to an artificial intelligence AI service; and the communication interface is further configured to send feedback information of the requirement information to the second device, where the feedback information is used to indicate whether to agree with a requirement corresponding to the requirement information.

According to a seventh aspect, a second device is provided. The second device includes a processor and a memory, the memory stores a program or an instruction that can be run on the processor, and the program or the instruction is executed by the processor to implement the steps of the method according to the second aspect.

According to an eighth aspect, a second device is provided, including a processor and a communication interface. The communication interface is configured to send requirement information to a first device, where the requirement information is used to indicate a requirement corresponding to an artificial intelligence AI service; and the communication interface is further configured to receive feedback information of the requirement information and sent by the first device, where the feedback information is used to indicate whether to agree with a requirement corresponding to the requirement information.

According to a ninth aspect, an information feedback system is provided, including a first device and a second device. The first device may be configured to perform the steps of the information feedback method according to the first aspect, and the second device may be configured to perform the steps of the information feedback method according to the second aspect.

According to a tenth aspect, a readable storage medium is provided. The readable storage medium stores a program or an instruction, and the program or the instruction is executed by a processor to implement the steps of the method according to the first aspect or the steps of the method according to the second aspect.

According to an eleventh aspect, a chip is provided. The chip includes a processor and a communication interface, the communication interface is coupled to the processor, and the processor is configured to run a program or an instruction to implement the method according to the first aspect or the method according to the second aspect.

According to a twelfth aspect, a computer program/program product is provided. The computer program/program product is stored in a storage medium, and the computer program/program product is executed by at least one processor to implement the steps of the information feedback method according to the first aspect, or the computer program/program product is executed by at least one processor to implement the steps of the information feedback method according to the second aspect.

### BRIEF DESCRIPTION OF DRAWINGS

FIG. 1 is a block diagram of a wireless communication system to which the embodiments of this application are applicable;

FIG. 2 is a first flowchart of an information feedback method according to an embodiment of this application;

FIG. 3 is a second flowchart of an information feedback method according to an embodiment of this application;

FIG. 4 is a first structural diagram of an information feedback apparatus according to an embodiment of this application;

FIG. 5 is a second structural diagram of an information feedback apparatus according to an embodiment of this application;

FIG. 6 is a structural diagram of a communication device according to an embodiment of this application;

FIG. 7 is a schematic structural diagram of a terminal according to an embodiment of this application; and

FIG. 8 is a schematic structural diagram of a network side device according to an embodiment of this application.

### DETAILED DESCRIPTION OF THE INVENTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th generation (6G) communication system.

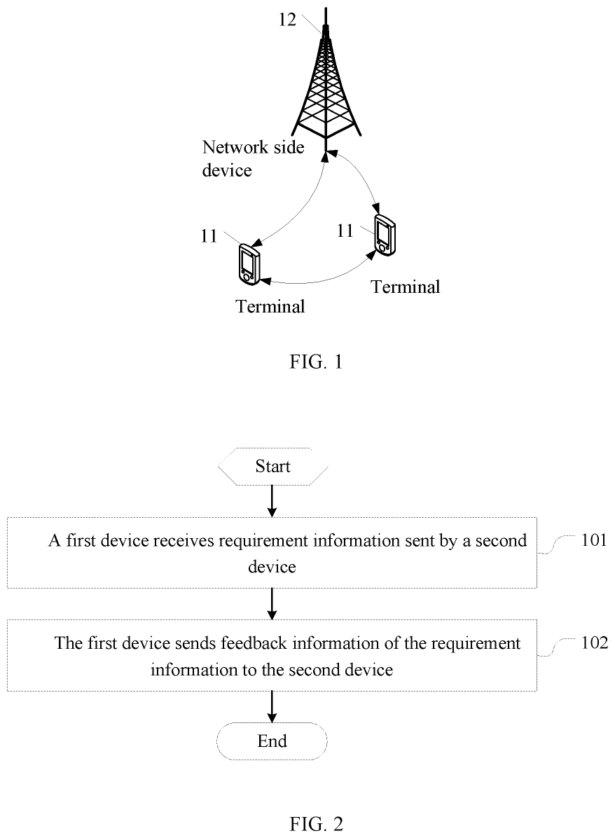

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a radio access network (RAN), a radio access network function, or a radio access network unit. The access network device may include a base station, a wireless local area network (WLAN) access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the field. As long as a same technical effect is achieved, the base station is not limited to a specified technical term. It should be noted that, in this application, only a base station in an NR system is used as an example, and a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rule function unit (PCRF), an edge application server discovery function (EASDF), unified data management (UDM), a unified data repository (UDR), a home subscriber server (HSS), a centralized network configuration (CNC), a network repository function (NRF), a network exposure function (NEF), a local NEF (Local NEF, or L-NEF), a binding support function (BSF), an application function (AF), and the like. It should be noted that, in the embodiments of this application, only a core network device in an NR system is used as an example for description, and a specific type of the core network device is not limited.

With reference to the accompanying drawings, the following describes in detail an information feedback method and apparatus, and a device provided in the embodiments of this application by using some embodiments and application scenarios thereof.

Referring to FIG. 2, FIG. 2 is a flowchart of an information feedback method according to an embodiment of this application. As shown in FIG. 2, the information feedback method includes the following steps.

Step 101: A first device receives requirement information sent by a second device, where the requirement information is used to indicate a requirement corresponding to an artificial intelligence AI service.

The AI service may include services related to an AI neural network model, such as model training, model fine-tuning, model inference, and model validation. It should be noted that, for an AI neural network model trained based on simulation data or sample data collected from another cell, due to the problem of generalization, the performance is often not very good if inference is performed directly in a cell where the terminal is located. The terminal may further train the AI neural network model based on data from the cell in which the terminal is located or improve performance of the AI neural network model through an AI service such as fine-tuning.

In an implementation, the AI service may include at least one of model training, fine-tuning, model inference, and model validation.

In addition, the first device may be a terminal, a base station, a core network element, or the like. The second device may be a base station, a self-organized network (SON), an operation administration and maintenance (OAM) system, a core network element (for example, a network data analytics function (NWDAF)), or a network management system.

Step 102: The first device sends feedback information of the requirement information to the second device, where the feedback information is used to indicate whether to agree with a requirement corresponding to the requirement information.

The feedback information may be capability feedback information. For example, the feedback information may be intelligent capability feedback information, and the intelligent capability feedback information is used to indicate an intelligent capability of the first device.

It should be noted that the first device may be used for AI service execution and intelligent capability reporting, and the second device may be used for AI service orchestration deployment. The AI service may be split into three dimensions: an AI computing power, an AI algorithm, and AI data by means of AI service orchestration deployment. In this embodiment of this application, the first device receives the requirement information corresponding to the AI service, performs evaluation according to a capability of the first device, and reports acceptance, rejection, or a requirement difference. Therefore, an execution end of the AI service may execute, within a capability range of the execution end, an AI service allocated by an AI service orchestration deployment node, so that the first device can provide a high-quality AI service and ensure normal operating of other procedures of the first device.

In an implementation, the first device receives the requirement information sent by the second device, where the requirement information includes requirements for an AI computing power and/or an AI algorithm and/or AI data. The first device may send the feedback information of the requirement information to the second device, where the feedback information may include acceptance, rejection, or capability difference information, and the capability difference information may be used to indicate a difference between a device capability and the requirement information. For example, the first device may send the feedback information of the requirement information to the second device according to a decision of the first device.

It should be noted that the first device may be a terminal. If a current state of the terminal does not meet an expectation, the terminal accepts an allocated AI service, which may affect normal operating of other procedures of the terminal, and also cannot ensure high quality completion of the AI service by the terminal. In this embodiment of this application, the terminal receives requirement information sent by an AI service orchestration deployment device, where the requirement information is used to indicate a requirement corresponding to an artificial intelligence AI service; and sends feedback information of the requirement information to the AI service orchestration deployment device. Therefore, before receiving the AI service sent by the AI service orchestration deployment device, the terminal can comprehensively consider a requirement of the AI service and an intelligent capability of the device, and perform feedback, so that an intelligent capability feedback problem can be resolved from a procedure of deploying the AI service.

In an implementation, the requirement information includes an AI data requirement, and the feedback information may be used to feed back an AI data requirement difference. For example, the feedback information may include an information entry that the AI data requirement cannot be met in the requirement information and/or a current device capability of the first device corresponding to the information entry that the AI data requirement cannot be met in the requirement information.

In an implementation, the requirement information includes an AI computing power requirement, and the feedback information may be used to feed back an AI computing power requirement difference. For example, the feedback information may include an information entry that the AI computing power requirement cannot be met in the requirement information and/or a current device capability of the first device corresponding to the information entry that the AI computing power requirement cannot be met in the requirement information.

In an implementation, the requirement information includes an AI algorithm requirement, and the feedback information may be used to feed back an AI algorithm requirement difference. For example, the feedback information may include an information entry that the AI algorithm requirement cannot be met in the requirement information and/or a current device capability of the first device corresponding to the information entry that the AI algorithm requirement cannot be met in the requirement information.

It should be noted that the first device may determine, with reference to a device capability of the device in aspects such as a computing power, an algorithm, and data, whether the device capability of the first device meets the requirement information and whether to accept the requirement corresponding to the requirement information, and determine the feedback information. For example, if the device capability of the first device meets the requirement information and the requirement corresponding to the requirement information is to be accepted, the feedback information may be used to indicate to accept the requirement; and/or if the first device is not to accept the requirement corresponding to the requirement information, the feedback information may be used to indicate to reject the requirement; and/or if the device capability of the first device does not meet the requirement information but the requirement corresponding to the requirement information is to be accepted, the feedback information may be used to indicate the capability difference information.

In this embodiment of this application, a first device receives requirement information sent by a second device, where the requirement information is used to indicate a requirement corresponding to an artificial intelligence AI service; and the first device sends feedback information of the requirement information to the second device, where the feedback information is used to indicate whether to agree with a requirement corresponding to the requirement information. In this way, after receiving the requirement information sent by the second device, the first device sends the feedback information of the requirement information to the second device, so that a problem that normal operating of the device is affected when the device directly implements the AI service requirement can be avoided.

Optionally, the requirement information includes a requirement item, or a requirement item and a requirement value corresponding to the requirement item.

The requirement item may be used to indicate the requirement corresponding to the AI service. For example, the requirement item may include an AI computing power requirement, an AI algorithm requirement, an AI data requirement, and the like.

In an implementation, the first device receives the requirement information sent by the second device, where the requirement information includes a requirement item such as an AI computing power and/or an AI algorithm and/or AI data and a requirement value corresponding to the requirement item. The first device may send the feedback information of the requirement information to the second device, where the feedback information may be used to indicate acceptance, rejection, or capability difference information.

In an implementation, the first device receives the requirement information sent by the second device, where the requirement information includes a requirement item such as an AI computing power and/or an AI algorithm and/or an AI data. The first device may send the feedback information of the requirement information to the second device, where the feedback information may be used to indicate rejection or a device capability corresponding to the requirement item. The requirement item may be represented by a requirement entry. For example, the requirement information includes an AI computing power requirement entry, and the feedback information may include an AI computing power requirement entry value, where the AI computing power requirement entry value is assigned to a device capability corresponding to the AI computing power requirement entry; and/or the requirement information includes an AI algorithm requirement entry, and the feedback information may include an AI algorithm requirement entry value, where the AI algorithm requirement entry value is assigned to a device capability corresponding to the AI algorithm requirement entry; and/or the requirement information includes an AI data requirement entry, and the feedback information may include an AI data requirement entry value, where the AI data requirement entry value is assigned to a device capability corresponding to the AI data requirement entry.

In addition, in a case that the requirement information includes a requirement item, the first device may determine, with reference to a state of the device, whether a requirement corresponding to the requirement item is to be accepted, and determine the feedback information. For example, if the first device is not to accept the requirement corresponding to the requirement item, the feedback information may indicate rejection; or if the first device is to accept the requirement corresponding to the requirement item, the feedback information may indicate a current device capability corresponding to the requirement item.

It should be noted that the second device may split the AI service in the three dimensions: the AI computing power, the AI algorithm, and the AI data, to obtain requirement items in the three dimensions. The requirement item in the AI computing power dimension may include at least one of the following: a computing power; storage; a total computing workload; a processing time limitation; and power consumption. The requirement item in the AI algorithm dimension may include at least one of the following: AI task classification; an AI learning framework; an AI network development environment; and an AI basic model library. The requirement item in the AI data dimension may include at least one of the following: label data; a number of label dimensions; a label dimension; an order of label dimensions; a data amount of a label dimension; a data interval of the label; AI model input data; a number of AI model input dimensions; an AI model input dimension; an order of AI model input dimensions; a data amount of an AI model input dimension; a collection interval of AI model input data; and an AI model label delay.

In this implementation, the requirement information includes a requirement item, and the requirement item can be used to indicate the requirement corresponding to the AI service, so that the first device can feed back a device capability corresponding to the requirement item to the second device by using the requirement item; or the requirement information includes a requirement item and a requirement value corresponding to the requirement item, and the requirement item and the requirement value can be used to indicate the requirement corresponding to the AI service, so that the second device can feed back, to the second device by using the requirement item and the requirement value, whether a device capability corresponding to the requirement item can meet the requirement value.

Optionally, in a case that the requirement information includes a requirement item and a requirement value corresponding to the requirement item, the feedback information includes any one of the following:
first indication information, where the first indication information is used to indicate to agree with the requirement item, and a device capability meets the requirement value;
second indication information, where the second indication information is used to indicate to agree with the requirement item, the second indication information carries a device capability or capability difference information corresponding to the requirement item, and the capability difference information is used to indicate a difference between the device capability and the requirement value; and
third indication information, where the third indication information is used to indicate to reject the requirement item.

In an implementation, that the first device sends feedback information of the requirement information to the second device may include:
sending the first indication information to the second device in a case that the device capability of the first device meets the requirement value and the first device agrees with the requirement item; and/or
sending the second indication information to the second device in a case that the device capability of the first device does not meet the requirement value and the first device agrees to meet a part of requirement values corresponding to the requirement item; and/or
sending the third indication information to the second device in a case that the device capability of the first device does not meet the requirement value and the first device does not agree with the requirement item.

In an implementation, that the first device sends feedback information of the requirement information to the second device may include:
sending the first indication information to the second device in a case that the device capability of the first device meets the requirement value and the first device can maintain normal operating of the first device while meeting the requirement value; and/or
sending the second indication information to the second device in a case that the device capability of the first device does not meet the requirement value and the first device can maintain normal operating of the first device while meeting a part of requirement values corresponding to the requirement item; and/or
sending the third indication information to the second device in a case that the device capability of the first device does not meet the requirement value and the first device can only maintain normal operating of the first device.

In an implementation, the first device may directly execute the AI service corresponding to the requirement item after sending the first indication information to the second device; or the first device may execute the AI service corresponding to the requirement item after receiving indication information that is sent by the second device for determining the execution.

In an implementation, the first device may directly execute the AI service corresponding to the requirement item after sending the second indication information to the second device; or the first device may execute the AI service corresponding to the requirement item after receiving indication information that is sent by the second device for determining the execution; or the first device may execute the AI service corresponding to the requirement item after receiving indication information that is sent by the second device and that is used to indicate to modify the requirement value. This implementation sets no limitation thereto. For example, after receiving the second indication information sent by the first device, the second device may send, to the first device, indication information for modifying the requirement value, and modify the requirement value to a requirement value that matches the device capability.

In an implementation, the first device sends the third indication information to the second device, that is, the first device rejects to execute the AI service corresponding to the requirement item.

In this implementation, through the first indication information, the second indication information, or the third indication information, the first device can feed back, to the second device, whether to agree with or reject the requirement item corresponding to the AI service, and feed back, to the second device, whether the device capability corresponding to the requirement item meets the requirement value, so that the first device executes the allocated AI service within a capability range of the first device.

Optionally, there are at least two requirement items, the second indication information carries a first requirement item and a device capability or capability difference information corresponding to the first requirement item, and the first requirement item is a requirement item that does not match the device capability in the at least two requirement items.

The capability difference information corresponding to the first requirement item may be used to indicate a difference between the device capability and a requirement value corresponding to the first requirement item. For example, the first requirement item is an AI computing power requirement, the AI computing power requirement includes a computing power, and a computing power value corresponding to the AI computing power requirement is 20 T floating point operations per second (FLOPs). If the first device determines that an actual computing power of a current device is 15 T FLOPS, the capability difference information corresponding to the first requirement item is 5 T FLOPS, and the device capability corresponding to the first requirement item is 15 T FLOPs. The second indication information may carry the capability difference information 5 T FLOPs or the device capability 15 T FLOPs. That the first requirement item does not match the device capability may be considered as that the requirement value corresponding to the first requirement item does not match the device capability. For example, the requirement value corresponding to the first requirement item may be greater than the device capability.

In this implementation, the second indication information carries the first requirement item and the device capability or the capability difference information corresponding to the first requirement item, so that after receiving the requirement corresponding to the AI service, the first device can feed back, to the second device, the first requirement item that the device capability of the first device cannot meet the requirement value, and feed back the capability difference information corresponding to the first requirement item.

Optionally, in a case that the requirement information includes a requirement item, the feedback information includes any one of the following:
fourth indication information, where the fourth indication information is used to indicate to reject the requirement item; and
fifth indication information, where the fifth indication information is used to indicate to agree with the requirement item, and the fifth indication information carries a device capability corresponding to the requirement item.

The device capability corresponding to the requirement item may be a current device capability corresponding to the requirement item. In an example in which the requirement item includes a computing power, the device capability corresponding to the requirement item may include a current computing power of the device.

In an implementation, that the first device sends feedback information of the requirement information to the second device may include:
sending the fourth indication information to the second device in a case that the first device does not agree with the requirement item; and/or
sending the fifth indication information to the second device in a case that the first device agrees with the requirement item.

In an implementation, that the first device sends feedback information of the requirement information to the second device may include:
sending the fourth indication information to the second device in a case that the device capability of the first device can only maintain normal operating of the first device;
and/or
sending the fifth indication information to the second device in a case that the device capability of the first device can maintain normal operating of the first device and can meet the requirement item.

In an implementation, the first device sends the fourth indication information to the second device, that is, the first device rejects to execute the AI service corresponding to the requirement item.

In an implementation, after sending the fifth indication information to the second device, the first device may receive an instruction that is sent by the second device and that is for executing the AI service corresponding to the requirement item according to the device capability of the first device, and execute the AI service corresponding to the requirement item according to the current device capability of the first device. The second device may adjust task allocation of the AI service according to the device capability reported by the first device.

In this implementation, through the fourth indication information or the fifth indication information, the first device can feed back, to the second device, whether to agree with or reject the requirement item corresponding to the AI service, and feed back the device capability corresponding to the requirement item to the second device.

Optionally, the requirement item includes at least one of the following:
an AI computing power requirement, an AI algorithm requirement, and an AI data requirement.

In an implementation, that a first device receives requirement information sent by a second device includes: receiving, by the first device, an AI computing power requirement, and/or an AI computing power requirement and a requirement value corresponding to the AI computing power requirement sent by the second device.

That the first device sends feedback information of the requirement information to the second device includes: sending, by the first device, feedback information of the AI computing power requirement to the second device, where the feedback information is used to indicate whether to agree with the AI computing power requirement, and the feedback information further includes a device capability corresponding to the AI computing power requirement or capability difference information corresponding to the AI computing power requirement. Therefore, the device capability corresponding to the AI computing power requirement requested by the first device can be fed back to the second device.

In an implementation, that a first device receives requirement information sent by a second device includes: receiving, by the first device, an AI algorithm requirement, and/or an AI algorithm requirement and a requirement value corresponding to the AI algorithm requirement sent by the second device.

That the first device sends feedback information of the requirement information to the second device includes: sending, by the first device, feedback information of the AI algorithm requirement to the second device, where the feedback information is used to indicate whether to agree with the AI algorithm requirement, and the feedback information further includes a device capability corresponding to the AI algorithm requirement or capability difference information corresponding to the AI algorithm requirement. Therefore, the device capability corresponding to the AI algorithm requirement requested by the first device can be fed back to the second device.

In an implementation, that a first device receives requirement information sent by a second device includes: receiving, by the first device, an AI data requirement, and/or an AI data requirement and a requirement value corresponding to the AI data requirement sent by the second device.

That the first device sends feedback information of the requirement information to the second device includes: sending, by the first device, feedback information of the AI data requirement to the second device, where the feedback information is used to indicate whether to agree with the AI data requirement, and the feedback information further includes a device capability corresponding to the AI data requirement or capability difference information corresponding to the AI data requirement. Therefore, the device capability corresponding to the AI data requirement requested by the first device can be fed back to the second device.

In this implementation, the first device receives at least one of the AI computing power requirement, the AI algorithm requirement, and the AI data requirement that are sent by the second device, and sends feedback information corresponding to the requirement item to the second device, so that the first device provides an AI service with higher quality for the second device.

Optionally, the AI computing power requirement includes at least one of the following:
a computing power;
storage;
a total computing workload;
a processing time limitation; and
power consumption.

The computing power in the AI computing power requirement may be used to indicate a computing power that needs to be consumed by the AI service, and the computing power may be represented by multiply-accumulate operations/second. The storage in the AI computing power requirement may be used to indicate an amount of storage that needs to be consumed by the AI service. The total computing workload in the AI computing power requirement may be used to indicate a total computing workload for executing the AI service, and the total computing workload may be obtained by means of calculation by using the computing power and an inference time of the AI model. The processing time limitation in the AI computing power requirement may be used to indicate a time limitation for executing the AI service. The power consumption in the AI computing power requirement may be used to indicate electricity consumed by the AI service.

In an implementation, the first device receives the requirement information sent by the second device, where the requirement information includes at least one computing power requirement in a computing power, storage, a total computing workload, a processing time limitation, and power consumption, or at least one computing power requirement and a corresponding requirement value.

The first device sends the feedback information of the requirement information to the second device according to the device capability, where the feedback information may be used to indicate whether to agree with the at least one computing power requirement, and the feedback information may carry a device capability corresponding to the computing power requirement or capability difference information between the device capability and the requirement value.

In an implementation, the first device receives the requirement information sent by the second device, where the requirement information includes an AI algorithm requirement and an AI computing power requirement, the AI algorithm requirement includes at least one AI task in model training, model inference, model validation, model monitoring, and model deployment, and the AI computing power requirement includes at least one computing power requirement in a computing power, storage, a total computing workload, a processing time limitation, and power consumption that are required for executing the at least one AI task or at least one computing power requirement and a corresponding requirement value.

That the first device sends feedback information of the requirement information to the second device may include: determining, by the first device according to the device capability, whether the AI computing power requirement required for executing the at least one AI task can be met, and sending the first indication information to the second device in a case of determining that the AI computing power requirement required for executing the at least one AI task can be met; sending the second indication information to the second device in a case of determining that only a part of AI computing power requirements required for executing the at least one AI task can be met; and sending the third indication information to the second device in a case of determining that only normal operating of the first device can be maintained.

In an implementation, the first device receives the requirement information sent by the second device, where the requirement information includes an AI algorithm requirement and an AI computing power requirement, the AI algorithm requirement includes at least one AI task in model training, model inference, model validation, model monitoring, and model deployment, and the AI computing power requirement includes at least one computing power requirement in a computing power, storage, a total computing workload, a processing time limitation, and power consumption that are required for executing the at least one AI task.

That the first device sends feedback information of the requirement information to the second device may include: determining, by the first device according to the device capability, whether the at least one AI task can be executed in a case that normal operating of the device is maintained, and sending the fifth indication information to the second device in a case of determining that the at least one AI task can be executed in a case that normal operating of the device is maintained, where the fifth indication information carries the device capability corresponding to the at least one computing power requirement; and sending the fourth indication information to the second device in a case of determining that the at least one AI task cannot be executed in a case that normal operating of the device is maintained.

In this implementation, through at least one requirement item in a computing power, storage, a total computing workload, a processing time limitation, and power consumption in the AI computing power requirement, or a requirement item and a requirement value corresponding to the requirement item, the first device can determine whether the device capability of the first device can meet the AI computing power requirement.

Optionally, the AI algorithm requirement includes at least one of the following:
AI task classification;
an AI learning framework;
an AI network development environment; and
an AI basic model library.

The AI task classification may be used to indicate a task type corresponding to the AI algorithm. The AI learning framework may be used to indicate a learning framework of the AI algorithm, and specifically includes a learning method and a training method. The AI network development environment may be used to indicate a network development environment of the AI algorithm. The AI basic model library may be used to indicate a foundation model library of the AI algorithm.

In an implementation, the requirement information may include at least one requirement item in an AI learning framework, an AI network development environment, and an AI basic model library that are required for executing an AI task and a requirement value corresponding to the requirement item. That the first device sends feedback information of the requirement information to the second device may be: the first device determines, according to the device capability, whether to agree with the requirement corresponding to the requirement information, and sends feedback information to the second device, where the feedback information is used to indicate whether to agree with the requirement corresponding to the requirement information. For example, in an example in which the requirement information includes an AI learning framework, the requirement corresponding to the requirement information may be agreed when an AI algorithm of the first device is the AI learning framework.

In this implementation, through at least one requirement item in AI task classification, an AI learning framework, an AI network development environment, and an AI basic model library in the AI algorithm requirement, or a requirement item and a requirement value corresponding to the requirement item, the first device can determine whether the device capability of the first device can meet the AI algorithm requirement.

Optionally, the AI task classification includes at least one of the following:
model training;
model inference;
model validation;
model monitoring; and
model deployment.

In an implementation, the first device receives the requirement information sent by the second device, where the requirement information includes at least one AI task in model training, model inference, model validation, model monitoring, and model deployment. In a case that the device capability of the first device can only maintain normal operating of the first device, the first device sends, to the second device, feedback information that the requirement corresponding to the requirement information is agreed upon; and in a case that the device capability of the first device can maintain normal operating of the first device and the AI task can be executed, the first device sends, to the second device, feedback information that the requirement corresponding to the requirement information is agreed upon.

In an implementation, the first device receives the requirement information sent by the second device, where the requirement information includes at least one AI task in model training, model inference, model validation, model monitoring, and model deployment, and an AI algorithm requirement and/or an AI data requirement required for executing the AI task. If the device capability of the first device can meet the AI algorithm requirement and/or the AI data requirement, the first device agrees to execute the at least one AI task, and sends the feedback information of the requirement information to the second device, where the feedback information indicates to agree with the requirement corresponding to the requirement information; in a case that the device capability of the first device can partially meet the AI algorithm requirement and/or the AI data requirement, the first device agrees to execute the at least one AI task, and sends the feedback information of the requirement information to the second device, where the feedback information indicates to agree with the requirement corresponding to the requirement information, and feeds back capability difference information; and in a case that the device capability of the first device cannot meet the AI algorithm requirement and/or the AI data requirement, the first device rejects to execute the at least one AI task.

In this way, through feedback on requirements of AI tasks such as model training, model inference, model validation, model monitoring, and model deployment that are delivered by the second device, quality of executing the AI tasks such as model training, model inference, model validation, model monitoring, and model deployment by the first device can be improved.

Optionally, the AI learning framework includes at least one of the following:
supervised deep learning;
unsupervised deep learning;
meta-learning;
transfer learning;
reinforcement learning; and
federated learning.

It should be noted that the requirement information may include an AI learning framework required for executing an AI task. The AI learning framework is at least one of supervised deep learning, unsupervised deep learning, meta-learning, transfer learning, reinforcement learning, and federated learning. In a case that an AI algorithm of the first device is the AI learning framework indicated in the requirement information, the requirement corresponding to the requirement information may be agreed upon; and in a case that the AI algorithm of the first device is not the AI learning framework indicated in the requirement information, the requirement corresponding to the requirement information is rejected.

Optionally, the AI data requirement includes at least one of the following:
label data;
a number of label dimensions;
a label dimension;
an order of label dimensions;
a data amount of a label dimension;
a data interval of the label;
AI model input data;
a number of AI model input dimensions;
an AI model input dimension;
an order of AI model input dimensions;
a data amount of an AI model input dimension;
a collection interval of AI model input data; and
an AI model label delay.

The label data may include data related to communication of the first device, such as a reference signal received power (RSRP), reference signal receive power RSRP, and a signal-to-noise and interference ratio (SINR) that are of a beam channel. The number of label dimensions may be used to indicate a number of dimensions of label data that needs to be collected. The label dimension may be used to indicate a dimension of label data that needs to be collected. The order of label dimensions may be used to indicate an order of dimensions of label data that needs to be collected. The number of pieces of data in a label dimension may be used to indicate a number of pieces of data in each dimension of label data that needs to be collected. The data interval of the label may be used to indicate a data interval of label data that needs to be collected. The AI model input data may be used to indicate input data of an AI model. The number of AI model input dimensions may be used to indicate a number of dimensions of AI model input data that needs to be collected. The AI model input dimension may be used to indicate a dimension of AI model input data that needs to be collected. The order of AI model input dimensions may be used to indicate an order of dimensions of AI model input data that needs to be collected. The number of pieces of data in an AI model input dimension may be used to indicate a number of pieces of data in each dimension of AI model input data that needs to be collected. The collection interval of AI model input data is used to indicate a data interval of AI model input data that needs to be collected. The AI model label delay may be used to indicate a delay between obtaining of label data and ending of inference or receiving of AI model input data. Through the foregoing AI data requirement, the first device can determine whether the device capability of the first device can meet the AI data requirement.

In an implementation, the requirement information may include at least one piece of label data information in label data, a number of label dimensions, a label dimension, an order of label dimensions, a data amount of a label dimension, a data interval of the label, and an AI model label delay that are required for executing an AI task. The first device may determine, through the at least one piece of label data information, the label data required for executing the AI task. In an example in which the AI task is model training, the label data may be label data used for model training. The first device determines, according to the device capability, whether the label data required for executing the AI task can be obtained, and if the label data required for executing the AI task can be obtained, agrees with the requirement corresponding to the requirement information; or if the label data required for executing the AI task cannot be obtained, rejects the requirement corresponding to the requirement information. Therefore, the first device can collect the label data according to the device capability of the first device.

In an implementation, the requirement information may include at least one piece of AI model input data information in AI model input data, a number of AI model input dimensions, an AI model input dimension, an order of AI model input dimensions, a data amount of an AI model input dimension, and a collection interval of AI model input data that are required for executing an AI task. The first device may determine, through the at least one piece of AI model input data information, the AI model input data required for executing the AI task. In an example in which the AI task is model inference, the AI model input data may be input data used for model inference. The first device determines, according to the device capability, whether the AI model input data required for executing the AI task can be obtained, and if the AI model input data required for executing the AI task can be obtained, agrees with the requirement corresponding to the requirement information; or if the AI model input data required for executing the AI task cannot be obtained, rejects the requirement corresponding to the requirement information. Therefore, the first device can obtain the AI model input data according to the device capability of the first device.

Optionally, the label data is used to indicate at least one of the following:
a reference signal received power (RSRP) of a beam channel;
reference signal received quality (RSRQ) of a beam channel;
a signal-to-noise and interference ratio (SINR) of a beam channel;
an RSRP of a cell channel;
RSRQ of a cell channel;
an SINR of a cell channel;
a received signal strength indicator (RSSI) of a cell channel;
an impulse response of a cell channel;
a precoding matrix indicator (PMI);
a rank indicator (RI); and
a channel quality indicator (CQI).

Optionally, the data interval of the label is used to indicate at least one of the following:
a time interval;
a frequency interval;
a delay interval;
a phase interval;
a Doppler interval; and
a beam interval.

Optionally, the AI model label delay is used to indicate at least one of the following:
a delay between ending of inference and obtaining of label data; and
a delay between receiving of AI model input data and obtaining of label data.

The delay between ending of inference and obtaining of label data may be a delay between ending of inference by the first device and obtaining of label data by the first device. The delay between receiving of AI model input data and obtaining of label data may be a delay between receiving of AI model input data by the first device and obtaining of label data by the first device.

The following describes the information feedback method in the embodiments of this application by using three specific embodiments.

### Embodiment 1

A first device may be a terminal, a second device may be a core network element, and an AI service may be model training.

The terminal receives requirement information sent by the core network element, where the requirement information includes an AI data requirement, and the AI data requirement in the requirement information specifies that the number of AI model input dimensions is two dimensions: a transmit beam dimension and a time dimension, where a number of transmit beam dimensions is 64.

The terminal may measure that a number of current transmit beam dimensions is 8, and the terminal is to accept the requirement information, but needs to feed back an entry of a difference between a current data collection situation and the requirement information: the number of transmit beam dimensions and the number 8 of current transmit beam dimensions of the terminal. The terminal sends feedback information to the core network element, where the feedback information includes the entry of the difference: the number of transmit beam dimensions and the number 8 of current transmit beam dimensions of the terminal.

In this embodiment, the terminal reports capability difference information corresponding to the AI data requirement to the core network element.

### Embodiment 2

A first device may be a terminal, a second device may be a core network element, and an AI service may be model training.

The terminal receives requirement information sent by the core network element, where the requirement information includes an AI computing power requirement, and a computing power defined by the AI computing power requirement in the requirement information is 20 T FLOPS.

An actual computing power evaluated by the terminal according to a capability of the terminal is 15 T FLOPS. In this case, the terminal is to accept the requirement information but cannot support the requirement information due to the capability of the terminal. The terminal sends feedback information to the core network element, where the feedback information includes: an entry that is different from the requirement information: the computing power, and the current actual computing power 15 T FLOPS.

In this embodiment, the terminal reports capability difference information corresponding to the AI computing power requirement to the core network element.

### Embodiment 3

A first device may be a terminal, a second device may be a core network element, and an AI service may be model training.

The terminal receives requirement information sent by the core network element, where the requirement information includes an AI algorithm requirement, and a foundation mode defined by the AI algorithm requirement in the requirement information is a convolutional neural network model.

A model currently stored by the terminal is only a fully-connected model, and the terminal is to accept the requirement information but cannot support the requirement information due to a capability of the terminal. The terminal sends feedback information to the core network element, where the feedback information includes an algorithm difference entry: the foundation mode, and a current value: the fully-connected model.

In this embodiment, the terminal reports capability difference information corresponding to the AI algorithm requirement to the core network element.

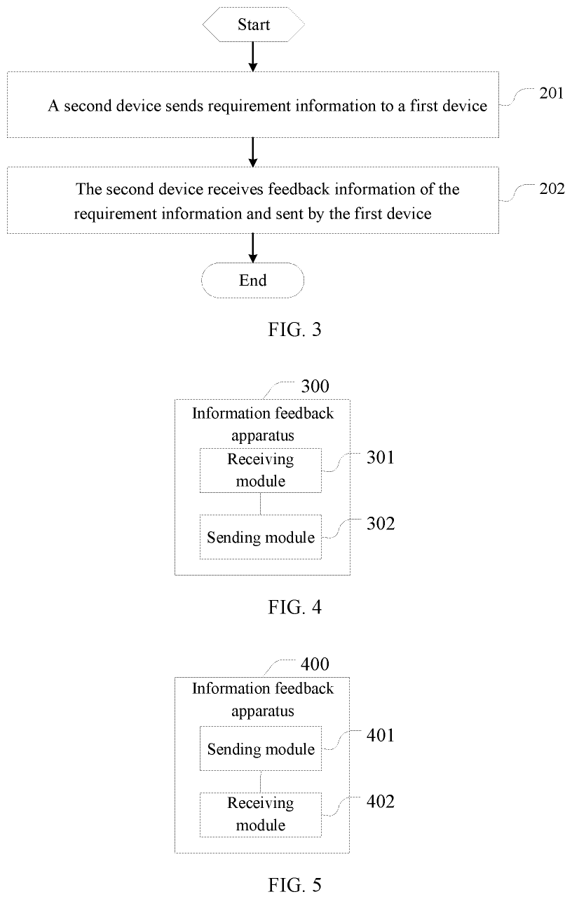

Referring to FIG. 3, FIG. 3 is a flowchart of an information feedback method according to an embodiment of this application. As shown in FIG. 3, the information feedback method includes the following steps.

Step 201: A second device sends requirement information to a first device, where the requirement information is used to indicate a requirement corresponding to an artificial intelligence AI service.

Step 202: The second device receives feedback information of the requirement information and sent by the first device, where the feedback information is used to indicate whether to agree with a requirement corresponding to the requirement information.

Optionally, the requirement information includes a requirement item, or a requirement item and a requirement value corresponding to the requirement item.

Optionally, in a case that the requirement information includes a requirement item and a requirement value corresponding to the requirement item, the feedback information includes any one of the following:
first indication information, where the first indication information is used to indicate to agree with the requirement item, and a device capability meets the requirement value;
second indication information, where the second indication information is used to indicate to agree with the requirement item, the second indication information carries a device capability or capability difference information corresponding to the requirement item, and the capability difference information is used to indicate a difference between the device capability and the requirement value; and
third indication information, where the third indication information is used to indicate to reject the requirement item.

Optionally, there are at least two requirement items, the second indication information carries a first requirement item and a device capability or capability difference information corresponding to the first requirement item, and the first requirement item is a requirement item that does not match the device capability in the at least two requirement items.

Optionally, in a case that the requirement information includes a requirement item, the feedback information includes any one of the following:
fourth indication information, where the fourth indication information is used to indicate to reject the requirement item; and
fifth indication information, where the fifth indication information is used to indicate to agree with the requirement item, and the fifth indication information carries a device capability corresponding to the requirement item.

Optionally, the requirement item includes at least one of the following:
an AI computing power requirement, an AI algorithm requirement, and an AI data requirement.

It should be noted that this embodiment is used as an implementation of the second device corresponding to the embodiment shown in FIG. 2. For a specific implementation of this embodiment, refer to the related descriptions of the embodiment shown in FIG. 2. To avoid repetition, details are not described in this embodiment. In this way, a problem that normal operating of the device is affected when the first device directly implements the AI service requirement can be avoided.

The information feedback method provided in the embodiments of this application may be performed by an information feedback apparatus. In the embodiments of this application, an example in which the information feedback apparatus performs the information feedback method is used to describe the information feedback apparatus provided in the embodiments of this application.

Referring to FIG. 4, FIG. 4 is a structural diagram of an information feedback apparatus according to an embodiment of this application. A first device includes the information feedback apparatus. As shown in FIG. 4, an information feedback apparatus 300 includes:
a receiving module 301, configured to receive requirement information sent by a second device, where the requirement information is used to indicate a requirement corresponding to an artificial intelligence AI service; and
a sending module 302, configured to send feedback information of the requirement information to the second device, where the feedback information is used to indicate whether to agree with a requirement corresponding to the requirement information.

Optionally, the requirement information includes a requirement item, or a requirement item and a requirement value corresponding to the requirement item.

Optionally, in a case that the requirement information includes a requirement item and a requirement value corresponding to the requirement item, the feedback information includes any one of the following:
first indication information, where the first indication information is used to indicate to agree with the requirement item, and a device capability meets the requirement value;
second indication information, where the second indication information is used to indicate to agree with the requirement item, the second indication information carries a device capability or capability difference information corresponding to the requirement item, and the capability difference information is used to indicate a difference between the device capability and the requirement value; and
third indication information, where the third indication information is used to indicate to reject the requirement item.

Optionally, there are at least two requirement items, the second indication information carries a first requirement item and a device capability or capability difference information corresponding to the first requirement item, and the first requirement item is a requirement item that does not match the device capability in the at least two requirement items.

Optionally, in a case that the requirement information includes a requirement item, the feedback information includes any one of the following:
fourth indication information, where the fourth indication information is used to indicate to reject the requirement item; and
fifth indication information, where the fifth indication information is used to indicate to agree with the requirement item, and the fifth indication information carries a device capability corresponding to the requirement item.

Optionally, the requirement item includes at least one of the following:
an AI computing power requirement, an AI algorithm requirement, and an AI data requirement.

Optionally, the AI computing power requirement includes at least one of the following: a computing power;
storage;
a total computing workload;
a processing time limitation; and
power consumption.

Optionally, the AI algorithm requirement includes at least one of the following:
AI task classification;
an AI learning framework;
an AI network development environment; and
an AI basic model library.

Optionally, the AI task classification includes at least one of the following:
model training;
model inference;
model validation;
model monitoring; and
model deployment.

Optionally, the AI learning framework includes at least one of the following:
supervised deep learning;
unsupervised deep learning;
meta-learning;
transfer learning;
reinforcement learning; and
federated learning.

Optionally, the AI data requirement includes at least one of the following:
label data;
a number of label dimensions;
a label dimension;
an order of label dimensions;
a data amount of a label dimension;
a data interval of the label;
AI model input data;
a number of AI model input dimensions;
an AI model input dimension;
an order of AI model input dimensions;
a data amount of an AI model input dimension;
a collection interval of AI model input data; and
an AI model label delay.

Optionally, the label data is used to indicate at least one of the following:
a reference signal received power RSRP of a beam channel;
reference signal received quality RSRQ of a beam channel;
a signal-to-noise and interference ratio SINR of a beam channel;
an RSRP of a cell channel;
RSRQ of a cell channel;
an SINR of a cell channel;
a received signal strength indicator RSSI of a cell channel;
an impulse response of a cell channel;
a precoding matrix indicator PMI;
a rank indicator RI; and
a channel quality indicator CQI.

Optionally, the data interval of the label is used to indicate at least one of the following:
a time interval;
a frequency interval;
a delay interval;
a phase interval;
a Doppler interval; and
a beam interval.

Optionally, the AI model label delay is used to indicate at least one of the following:
a delay between ending of inference and obtaining of label data; and
a delay between receiving of AI model input data and obtaining of label data.

According to the information feedback apparatus in this embodiment of this application, after requirement information sent by a second device is received, feedback information of the requirement information is sent to the second device, so that a problem that normal operating of the device is affected when the device directly implements the AI service requirement can be avoided.

The information feedback apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed type of the terminal 11. The another device may be a server, a network attached storage (NAS), or the like. This is not specifically limited in this embodiment of this application.

The information feedback apparatus provided in this embodiment of this application can implement the processes implemented in the method embodiment of FIG. 2, and achieve a same technical effect. To avoid repetition, details are not described herein again.

Referring to FIG. 5, FIG. 5 is a structural diagram of an information feedback apparatus according to an embodiment of this application. A second device includes the information feedback apparatus. As shown in FIG. 5, an information feedback apparatus 400 includes:

a sending module 401, configured to send requirement information to a first device, where the requirement information is used to indicate a requirement corresponding to an artificial intelligence AI service; and a receiving module 402, configured to receive feedback information of the requirement information and sent by the first device, where the feedback information is used to indicate whether to agree with a requirement corresponding to the requirement information.

Optionally, the requirement information includes a requirement item, or a requirement item and a requirement value corresponding to the requirement item.

Optionally, in a case that the requirement information includes a requirement item and a requirement value corresponding to the requirement item, the feedback information includes any one of the following:
first indication information, where the first indication information is used to indicate to agree with the requirement item, and a device capability meets the requirement value;
second indication information, where the second indication information is used to indicate to agree with the requirement item, the second indication information carries a device capability or capability difference information corresponding to the requirement item, and the capability difference information is used to indicate a difference between the device capability and the requirement value; and
third indication information, where the third indication information is used to indicate to reject the requirement item.

Optionally, there are at least two requirement items, the second indication information carries a first requirement item and a device capability or capability difference information corresponding to the first requirement item, and the first requirement item is a requirement item that does not match the device capability in the at least two requirement items.

Optionally, in a case that the requirement information includes a requirement item, the feedback information includes any one of the following:
fourth indication information, where the fourth indication information is used to indicate to reject the requirement item; and
fifth indication information, where the fifth indication information is used to indicate to agree with the requirement item, and the fifth indication information carries a device capability corresponding to the requirement item.

Optionally, the requirement item includes at least one of the following:
an AI computing power requirement, an AI algorithm requirement, and an AI data requirement.

According to the information feedback apparatus in this embodiment of this application, a problem that normal operating of the device is affected when the first device directly implements the AI service requirement can be avoided.

The information feedback apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed type of the terminal 11. The another device may be a server, a network attached storage (NAS), or the like. This is not specifically limited in this embodiment of this application.

The information feedback apparatus provided in this embodiment of this application can implement the processes implemented in the method embodiment of FIG. 3, and achieve a same technical effect. To avoid repetition, details are not described herein again.

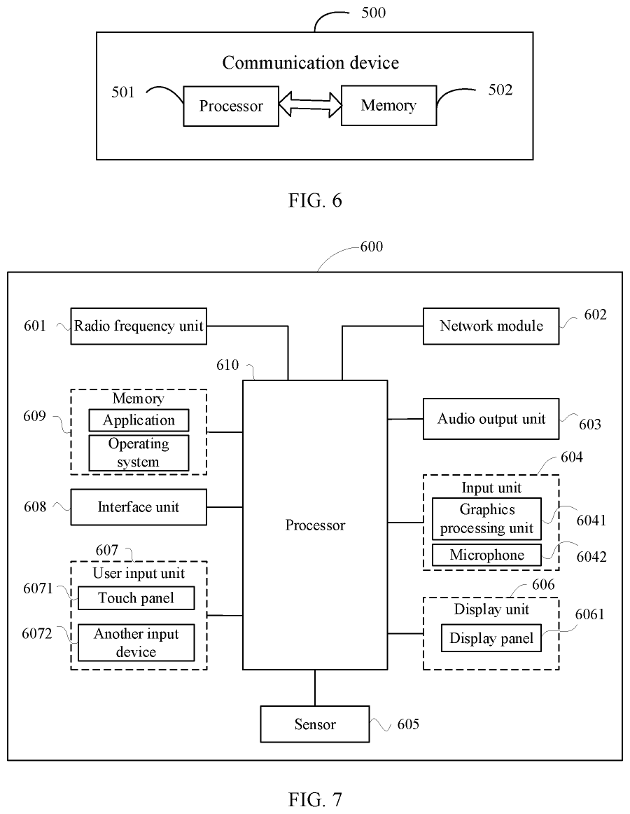

Optionally, as shown in FIG. 6, an embodiment of this application further provides a communication device 500, including a processor 501 and a memory 502. The memory 502 stores a program or an instruction that can be run on the processor 501. For example, when the communication device 500 is a first device, the program or the instruction is executed by the processor 501 to implement the steps of the foregoing information feedback method embodiment applied to the first device, and a same technical effect can be achieved. When the communication device 500 is a second device, the program or the instruction is executed by the processor 501 to implement the steps of the foregoing information feedback method embodiment applied to the second device, and a same technical effect can be achieved. To avoid repetition, details are not described herein again.

An embodiment of this application further provides a terminal. The terminal may be a first device, including a processor and a communication interface. The communication interface is configured to receive requirement information sent by a second device, where the requirement information is used to indicate a requirement corresponding to an artificial intelligence AI service; and the communication interface is further configured to send feedback information of the requirement information to the second device, where the feedback information is used to indicate whether to agree with a requirement corresponding to the requirement information. This terminal embodiment corresponds to the foregoing method embodiment on the first device side. Each implementation process and implementation of the foregoing method embodiment may be applicable to this terminal embodiment, and a same technical effect can be achieved. Specifically, FIG. 7 is a schematic diagram of a hardware structure of a terminal according to an embodiment of this application.

The terminal 600 includes but is not limited to components such as a radio frequency unit 601, a network module 602, an audio output unit 603, an input unit 604, a sensor 605, a display unit 606, a user input unit 607, an interface unit 608, a memory 609, and a processor 610.

A person skilled in the art can understand that the terminal 600 may further include the power supply (for example, a battery) that supplies power to each component. The power supply may be logically connected to the processor 610 by using a power supply management system, so as to manage functions such as charging, discharging, and power consumption by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that, in this embodiment of this application, the input unit 604 may include a graphics processing unit (GPU) 6041 and a microphone 6042, and the graphics processing unit 6041 processes image data of a still image or a video that is obtained by an image capturing apparatus (for example, a camera) in a video capturing mode or an image capturing mode. The display unit 606 may include a display panel 6061. The display panel 6061 may be configured in a form such as a liquid crystal display or an organic light-emitting diode. The user input unit 607 includes at least one of a touch panel 6071 and another input device 6072. The touch panel 6,071 is also referred to as a touchscreen. The touch panel 6071 may include two parts: a touch detection apparatus and a touch controller. The another input device 6072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 601 may transmit the downlink data to the processor 610 for processing. In addition, the radio frequency unit 601 may send uplink data to the network side device. Usually, the radio frequency unit 601 includes but is not limited to an antenna, an amplifier, a transceiver, a coupler, a low noise amplifier, a duplexer, and the like.

The memory 609 may be configured to store a software program or an instruction and various data. The memory 609 may mainly include a first storage area for storing a program or an instruction and a second storage area for storing data. The first storage area may store an operating system, and an application or an instruction required by at least one function (for example, a sound playing function or an image playing function). In addition, the memory 609 may be a volatile memory or a non-volatile memory, or the memory 609 may include a volatile memory and a non-volatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 609 in this embodiment of this application includes but is not limited to these memories and a memory of any other proper type.

The processor 610 may include one or more processing units. Optionally, an application processor and a modem processor are integrated into the processor 610. The application processor mainly processes an operating system, a user interface, an application, and the like. The modem processor mainly processes a wireless communication signal, for example, a baseband processor. It can be understood that, alternatively, the modem processor may not be integrated into the processor 610.

The terminal may be a first device.

The radio frequency unit 601 is configured to receive requirement information sent by a second device, where the requirement information is used to indicate a requirement corresponding to an artificial intelligence AI service.

The radio frequency unit 601 is further configured to send feedback information of the requirement information to the second device, where the feedback information is used to indicate whether to agree with a requirement corresponding to the requirement information.

Optionally, the requirement information includes a requirement item, or a requirement item and a requirement value corresponding to the requirement item.

Optionally, in a case that the requirement information includes a requirement item and a requirement value corresponding to the requirement item, the feedback information includes any one of the following:
first indication information, where the first indication information is used to indicate to agree with the requirement item, and a device capability meets the requirement value;
second indication information, where the second indication information is used to indicate to agree with the requirement item, the second indication information carries a device capability or capability difference information corresponding to the requirement item, and the capability difference information is used to indicate a difference between the device capability and the requirement value; and
third indication information, where the third indication information is used to indicate to reject the requirement item.

Optionally, there are at least two requirement items, the second indication information carries a first requirement item and a device capability or capability difference information corresponding to the first requirement item, and the first requirement item is a requirement item that does not match the device capability in the at least two requirement items.

Optionally, in a case that the requirement information includes a requirement item, the feedback information includes any one of the following:
fourth indication information, where the fourth indication information is used to indicate to reject the requirement item; and
fifth indication information, where the fifth indication information is used to indicate to agree with the requirement item, and the fifth indication information carries a device capability corresponding to the requirement item.

Optionally, the requirement item includes at least one of the following:
an AI computing power requirement, an AI algorithm requirement, and an AI data requirement.

Optionally, the AI computing power requirement includes at least one of the following:
a computing power;
storage;
a total computing workload;
a processing time limitation; and
power consumption.

Optionally, the AI algorithm requirement includes at least one of the following:
AI task classification;
an AI learning framework;
an AI network development environment; and
an AI basic model library.

Optionally, the AI task classification includes at least one of the following:
model training;
model inference;
model validation;
model monitoring; and
model deployment.

Optionally, the AI learning framework includes at least one of the following:
supervised deep learning;
unsupervised deep learning;
meta-learning;
transfer learning;
reinforcement learning; and
federated learning.

Optionally, the AI data requirement includes at least one of the following:
label data;
a number of label dimensions;
a label dimension;
an order of label dimensions;
a data amount of a label dimension;
a data interval of the label;
AI model input data;
a number of AI model input dimensions;
an AI model input dimension;
an order of AI model input dimensions;
a data amount of an AI model input dimension;
a collection interval of AI model input data; and
an AI model label delay.

Optionally, the label data is used to indicate at least one of the following:
a reference signal received power RSRP of a beam channel;
reference signal received quality RSRQ of a beam channel;
a signal-to-noise and interference ratio SINR of a beam channel;
an RSRP of a cell channel;
RSRQ of a cell channel;
an SINR of a cell channel;
a received signal strength indicator RSSI of a cell channel;
an impulse response of a cell channel;
a precoding matrix indicator PMI;
a rank indicator RI; and
a channel quality indicator CQI.

Optionally, the data interval of the label is used to indicate at least one of the following:
a time interval;
a frequency interval;
a delay interval;
a phase interval;
a Doppler interval; and
a beam interval.

Optionally, the AI model label delay is used to indicate at least one of the following:
a delay between ending of inference and obtaining of label data; and
a delay between receiving of AI model input data and obtaining of label data.

In this implementation, after receiving requirement information sent by a second device, a terminal sends feedback information of the requirement information to the second device, so that a problem that normal operating of the device is affected when the device directly implements the AI service requirement can be avoided.

An embodiment of this application further provides a network side device, including a processor and a communication interface. The communication interface is configured to: receive requirement information sent by a second device, where the requirement information is used to indicate a requirement corresponding to an artificial intelligence AI service; and send feedback information of the requirement information to the second device, where the feedback information is used to indicate whether to agree with a requirement corresponding to the requirement information; or the communication interface is configured to: send requirement information to a first device, where the requirement information is used to indicate a requirement corresponding to an artificial intelligence AI service; and receive feedback information of the requirement information and sent by the first device, where the feedback information is used to indicate whether to agree with a requirement corresponding to the requirement information. This network side device embodiment corresponds to the foregoing method embodiment on the first device side or the foregoing method embodiment on the second device side. Each implementation process and implementation of the foregoing method embodiment may be applicable to this network side device embodiment, and a same technical effect can be achieved.

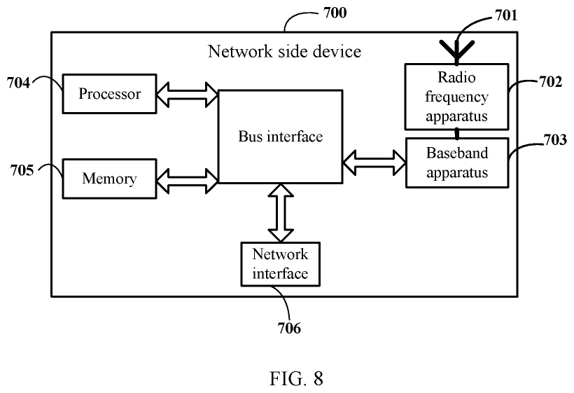

Specifically, an embodiment of this application further provides a network side device. As shown in FIG. 8, the network side device 700 includes an antenna 701, a radio frequency apparatus 702, a baseband apparatus 703, a processor 704, and a memory 705. The antenna 701 is connected to the radio frequency apparatus 702. In an uplink direction, the radio frequency apparatus 702 receives information by using the antenna 701, and sends the received information to the baseband apparatus 703 for processing. In a downlink direction, the baseband apparatus 703 processes information that needs to be sent, and sends processed information to the radio frequency apparatus 702. The radio frequency apparatus 702 processes the received information, and sends processed information by using the antenna 701.

In the foregoing embodiment, the method performed by the network side device may be implemented in the baseband apparatus 703. The baseband apparatus 703 includes a baseband processor.

The baseband apparatus 703 may include, for example, at least one baseband board, where a plurality of chips are disposed on the baseband board. As shown in FIG. 8, one chip is, for example, the baseband processor, is connected to the memory 705 through a bus interface, to invoke a program in the memory 705 to perform the operations of the network device shown in the foregoing method embodiment.

The network side device may further include a network interface 706, and the interface is, for example, a common public radio interface (CPRI).

Specifically, the network side device 700 in this embodiment of the present invention further includes an instruction or a program that is stored in the memory 705 and that can be run on the processor 704. The processor 704 invokes the instruction or the program in the memory 705 to perform the method performed by the modules shown in FIG. 4 or FIG. 5, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing information feedback method embodiment, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing information feedback method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing information feedback method embodiment, and a same technical effect can be achieved. To avoid repetition, details are not described herein again.

An embodiment of this application further provides an information feedback system, including a first device and a second device. The first device may be configured to perform the steps of the information feedback method on the first device side, and the second device may be configured to perform the steps of the information receiving method on the second device side.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In most circumstances, the former is a preferred implementation manner. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. An information feedback method, comprising:
receiving, by a first device, requirement information sent by a second device, wherein the requirement information is used to indicate a requirement corresponding to an artificial intelligence (AI) service; and
sending, by the first device, feedback information of the requirement information to the second device, wherein the feedback information is used to indicate whether to agree with a requirement corresponding to the requirement information.

2. The method according to claim 1, wherein the requirement information comprises a requirement item, or a requirement item and a requirement value corresponding to the requirement item.

3. The method according to claim 2, wherein in a case that the requirement information comprises a requirement item and a requirement value corresponding to the requirement item, the feedback information comprises any one of the following:
first indication information, wherein the first indication information is used to indicate to agree with the requirement item, and a device capability meets the requirement value;
second indication information, wherein the second indication information is used to indicate to agree with the requirement item, the second indication information carries a device capability or capability difference information corresponding to the requirement item, and the capability difference information is used to indicate a difference between the device capability and the requirement value; or
third indication information, wherein the third indication information is used to indicate to reject the requirement item.

4. The method according to claim 3, wherein there are at least two requirement items, the second indication information carries a first requirement item and a device capability or capability difference information corresponding to the first requirement item, and the first requirement item is a requirement item that does not match the device capability in the at least two requirement items.

5. The method according to claim 2, wherein in a case that the requirement information comprises a requirement item, the feedback information comprises any one of the following:
fourth indication information, wherein the fourth indication information is used to indicate to reject the requirement item; or
fifth indication information, wherein the fifth indication information is used to indicate to agree with the requirement item, and the fifth indication information carries a device capability corresponding to the requirement item.

6. The method according to claim 2, wherein the requirement item comprises at least one of the following:
an AI computing power requirement, an AI algorithm requirement, or an AI data requirement.

7. The method according to claim 6, wherein the AI computing power requirement comprises at least one of the following:
a computing power;
storage;
a total computing workload;
a processing time limitation; or
power consumption.

8. The method according to claim 6, wherein the AI algorithm requirement comprises at least one of the following:
AI task classification;
an AI learning framework;
an AI network development environment; or
an AI basic model library.

9. The method according to claim 8, wherein the AI task classification comprises at least one of the following:
model training;
model inference;
model validation;
model monitoring; or
model deployment.

10. The method according to claim 8, wherein the AI learning framework comprises at least one of the following:
supervised deep learning;
unsupervised deep learning;
meta-learning;
transfer learning;
reinforcement learning; or
federated learning.

11. The method according to claim 8, wherein the AI data requirement comprises at least one of the following:
label data;
a number of label dimensions;
a label dimension;
an order of label dimensions;
a data amount of a label dimension;
a data interval of the label;
AI model input data;
a number of AI model input dimensions;
an AI model input dimension;
an order of AI model input dimensions;
a data amount of an AI model input dimension;
a collection interval of AI model input data; or
an AI model label delay.

12. The method according to claim 11,
wherein the label data is used to indicate at least one of the following:
a reference signal received power (RSRP) of a beam channel;
reference signal received quality (RSRQ) of a beam channel;
a signal-to-noise and interference ratio (SINR) of a beam channel;
an RSRP of a cell channel;
RSRQ of a cell channel;
an SINR of a cell channel;
a received signal strength indicator (RSSI) of a cell channel;
an impulse response of a cell channel;
a precoding matrix indicator (PMI);
a rank indicator (RI); or
a channel quality indicator (CQI);
or,
wherein the data interval of the label is used to indicate at least one of the following:
a time interval;
a frequency interval;
a delay interval;
a phase interval;
a Doppler interval; or
a beam interval;
or,
wherein the AI model label delay is used to indicate at least one of the following:
a delay between ending of inference and obtaining of label data; or
a delay between receiving of AI model input data and obtaining of label data.

13. An information feedback method, comprising:
sending, by a second device, requirement information to a first device, wherein the requirement information is used to indicate a requirement corresponding to an artificial intelligence (AI) service; and
receiving, by the second device, feedback information of the requirement information and sent by the first device, wherein the feedback information is used to indicate whether to agree with a requirement corresponding to the requirement information.

14. The method according to claim 13, wherein the requirement information comprises a requirement item, or a requirement item and a requirement value corresponding to the requirement item.

15. The method according to claim 14, wherein in a case that the requirement information comprises a requirement item and a requirement value corresponding to the requirement item, the feedback information comprises any one of the following:
first indication information, wherein the first indication information is used to indicate to agree with the requirement item, and a device capability meets the requirement value;
second indication information, wherein the second indication information is used to indicate to agree with the requirement item, the second indication information carries a device capability or capability difference information corresponding to the requirement item, and the capability difference information is used to indicate a difference between the device capability and the requirement value; or
third indication information, wherein the third indication information is used to indicate to reject the requirement item.

16. The method according to claim 15, wherein there are at least two requirement items, the second indication information carries a first requirement item and a device capability or capability difference information corresponding to the first requirement item, and the first requirement item is a requirement item that does not match the device capability in the at least two requirement items.

17. The method according to claim 14,
wherein in a case that the requirement information comprises a requirement item, the feedback information comprises any one of the following:
fourth indication information, wherein the fourth indication information is used to indicate to reject the requirement item; or
fifth indication information, wherein the fifth indication information is used to indicate to agree with the requirement item, and the fifth indication information carries a device capability corresponding to the requirement item;
or,
wherein the requirement item comprises at least one of the following:
an AI computing power requirement, an AI algorithm requirement, or an AI data requirement.

18. A first device, comprising a processor and a memory, wherein the memory stores a program or an instruction that can be run on the processor, wherein the program or the instruction, when executed by the processor, causes the first device to perform:
receiving requirement information sent by a second device, wherein the requirement information is used to indicate a requirement corresponding to an artificial intelligence (AI) service; and
sending feedback information of the requirement information to the second device, wherein the feedback information is used to indicate whether to agree with a requirement corresponding to the requirement information.

19. The first device according to claim 18, wherein the requirement information comprises a requirement item, or a requirement item and a requirement value corresponding to the requirement item.

20. A second device, comprising a processor and a memory, wherein the memory stores a program or an instruction that can be run on the processor, and the program or the instruction is executed by the processor to implement the steps of the information feedback method according to claim 13.
